(19) United States
(12) Patent Application Publication
(10) Pub. No.: US 2017/0019819 A1
(43) Pub. Date: Jan. 19, 2017

(54) DYNAMIC HANDOVER SYNCHRONIZATION

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/801,782

(22) Filed: Jul. 16, 2015

(51) Int. Cl. H04W 36/00; H04W 56/00; H04L 12/58; H04W 74/08; H04B 7/185

(52) U.S. Cl. CPC H04W 36/0005; H04W 74/0891; H04B 7/1855; H04L 51/20; H04W 56/0005; H04W 88/02

(57) ABSTRACT

A user equipment (UE) improves handover throughput by reducing communication interruptions during a handover transition. To reduce the communication interruptions, the UE determines whether to perform a synchronization channel decoding procedure for a synchronized handover to a second radio access technology (RAT) after receiving a handover command from one or more serving cells of a first RAT. The determination includes determining whether a communication condition is satisfied and performing the synchronized handover based on whether the communication condition is satisfied. The synchronization channel decoding procedure includes frequency correction channel (FCCH) tone detection and/or synchronization channel (SCH) decoding after the UE transitions to a target cell of the second RAT.

### BACKGROUND

Field

Aspects of the present disclosure relate generally to wireless communication systems, and more particularly, to dynamically determining whether to perform a synchronization channel decoding procedure for a synchronized handover to a second RAT (radio access technology) after receiving a handover command from a cell of a first RAT.

Background

Wireless communication networks are widely deployed to provide various communication services, such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, there exists a need for further improvements in wireless technology. Preferably, these improvements should be applicable to LTE and other multi-access technologies and the telecommunication standards that employ these technologies.

### SUMMARY

According to one aspect of the present disclosure, a method of wireless communication includes dynamically determining whether to perform a synchronization channel decoding procedure for a synchronized handover to a second RAT (radio access technology) after receiving a handover command from one or more serving cells of a first RAT. The synchronization channel decoding procedure includes frequency correction channel (FCCH) tone detection and/or synchronization channel (SCH) decoding after a user equipment (UE) transitions to a target cell of the second RAT.

According to another aspect of the present disclosure, an apparatus for wireless communication includes means for receiving a handover command from one or more serving cells of a first RAT (radio access technology). The apparatus may also include means for dynamically determining whether to perform a synchronization channel decoding procedure for a synchronized handover to a second RAT after receiving the handover command from the serving cell(s) of the first RAT. The synchronization channel decoding procedure includes frequency correction channel (FCCH) tone detection and/or synchronization channel (SCH) decoding after a user equipment (UE) transitions to a target cell of the second RAT.

Another aspect discloses an apparatus for wireless communication and includes a memory and one or more processors coupled to the memory. The processor(s) is configured to dynamically determine whether to perform a synchronization channel decoding procedure for a synchronized handover to a second RAT (radio access technology) after receiving a handover command at a receiver of a user equipment (UE) from one or more serving cells of a first RAT. The synchronization channel decoding procedure includes frequency correction channel (FCCH) tone detection and/or synchronization channel (SCH) decoding after a user equipment (UE) transitions to a target cell of the second RAT.

Yet another aspect discloses a computer program product for wireless communications in a wireless network having a non-transitory computer-readable medium. The computer-readable medium has non-transitory program code recorded thereon which, when executed by the processor(s), causes the processor(s) to dynamically determine whether to perform a synchronization channel decoding procedure for a synchronized handover to a second RAT (radio access technology) after receiving a handover command from one or more serving cells of a first RAT. The synchronization channel decoding procedure includes frequency correction channel (FCCH) tone detection and/or synchronization channel (SCH) decoding after a user equipment (UE) transitions to a target cell of the second RAT.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of a downlink frame structure in long term evolution (LTE).

FIG. 3 is a diagram illustrating an example of an uplink frame structure in long term evolution (LTE).

FIG. 4 is a block diagram conceptually illustrating an example of a telecommunications system employing a time division synchronous code division multiple access (TD-SCDMA) standard.

FIG. 5 is a block diagram conceptually illustrating an example of a frame structure for a time division synchronous code division multiple access carrier.

FIG. 6 is a block diagram illustrating an example of a global system for mobile communications (GSM) frame structure.

FIG. 7 is a block diagram conceptually illustrating an example of a base station in communication with a user equipment (UE) in a telecommunications system.

FIG. 8 is a block diagram illustrating the timing of channel carriers according to aspects of the present disclosure.

FIG. 9 is a diagram illustrating network coverage areas according to aspects of the present disclosure.

FIG. 10 is a block diagram illustrating a wireless communication network in accordance with aspects of the present disclosure.

FIG. 11 is an exemplary call flow diagram illustrating a signaling procedure for handover of UE communicating according to a single radio voice call continuity (SRVCC) procedure.

FIG. 12 is a call flow diagram of a handover procedure according to aspects of the present disclosure.

FIGS. 13-21 are diagrams of handover procedures including examples of the wireless communication conditions according to aspects of the present disclosure.

FIG. 22 is a flow diagram illustrating a method for wireless communication according to one aspect of the present disclosure.

FIG. 23 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

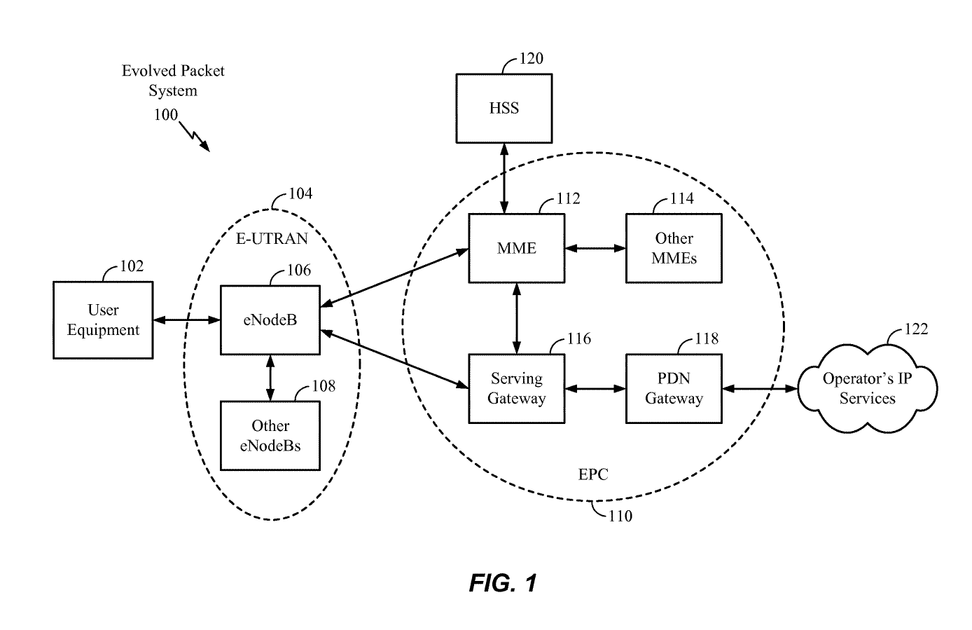

FIG. 1 is a diagram illustrating a network architecture 100 of a long-term evolution (LTE) network. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved NodeB (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a notebook, a netbook, a smartbook, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station or apparatus, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

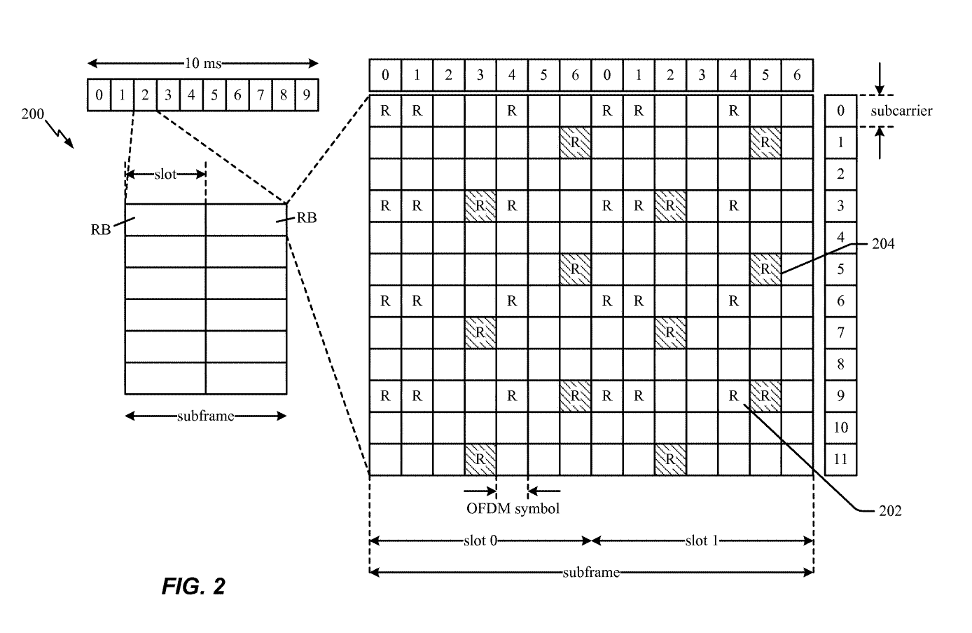

FIG. 2 is a diagram 200 illustrating an example of a downlink frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each orthogonal frequency division multiplexing (OFDM) symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204. UE-RS 204 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

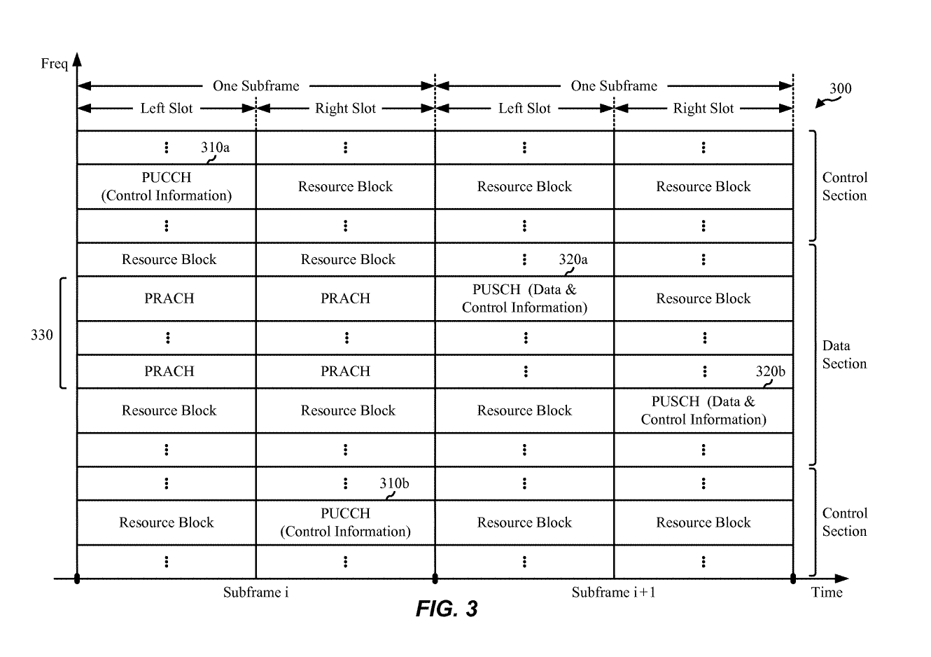

FIG. 3 is a diagram 300 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 310a, 310b in the control section to transmit control information to an eNodeB. The UE may also be assigned resource blocks 320a, 320b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 330. The PRACH 330 carries a random sequence and cannot carry any uplink data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

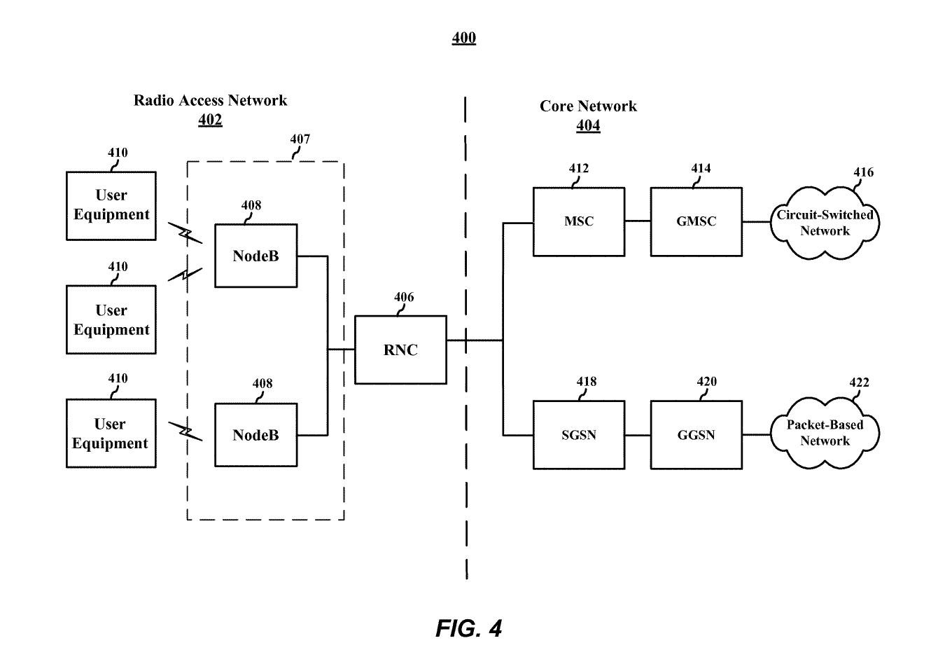

Turning now to FIG. 4, a block diagram is shown illustrating an example of a telecommunications system 400. The various concepts presented throughout this disclosure may be implemented across a broad variety of telecommunication systems, network architectures, and communication standards. By way of example and without limitation, the aspects of the present disclosure illustrated in FIG. 4 are presented with reference to a UMTS system employing a TD-SCDMA standard. In this example, the UMTS system includes a radio access network (RAN) 402 (e.g., UTRAN) that provides various wireless services including telephony, video, data, messaging, broadcasts, and/or other services. The RAN 402 may be divided into a number of radio network subsystems (RNSs) such as an RNS 407, each controlled by a radio network controller (RNC), such as an RNC 406. For clarity, only the RNC 406 and the RNS 407 are shown; however, the RAN 402 may include any number of RNCs and RNSs in addition to the RNC 406 and RNS 407. The RNC 406 is an apparatus responsible for, among other things, assigning, reconfiguring and releasing radio resources within the RNS 407. The RNC 406 may be interconnected to other RNCs (not shown) in the RAN 402 through various types of interfaces such as a direct physical connection, a virtual network, or the like, using any suitable transport network.

The geographic region covered by the RNS 407 may be divided into a number of cells, with a radio transceiver apparatus serving each cell. A radio transceiver apparatus is commonly referred to as a nodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two nodeBs 408 are shown; however, the RNS 407 may include any number of wireless nodeBs. The nodeBs 408 provide wireless access points to a core network 404 for any number of mobile apparatuses. For illustrative purposes, three UEs 410 are shown in communication with the nodeBs 408. The downlink (DL), also called the forward link, refers to the communication link from a nodeB to a UE, and the uplink (UL), also called the reverse link, refers to the communication link from a UE to a nodeB.

The core network 404, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 404 supports circuit-switched services with a mobile switching center (MSC) 412 and a gateway MSC (GMSC) 414. One or more RNCs, such as the RNC 406, may be connected to the MSC 412. The MSC 412 is an apparatus that controls call setup, call routing, and UE mobility functions. The MSC 412 also includes a visitor location register (VLR) (not shown) that contains subscriber-related information for the duration that a UE is in the coverage area of the MSC 412. The GMSC 414 provides a gateway through the MSC 412 for the UE to access a circuit-switched network 416. The GMSC 414 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 414 queries the HLR to determine the UE's location and forwards the call to the particular MSC serving that location.

The core network 404 also supports packet-data services with a serving GPRS support node (SGSN) 418 and a gateway GPRS support node (GGSN) 420. General packet radio service (GPRS) is designed to provide packet-data services at speeds higher than those available with standard GSM circuit-switched data services. The GGSN 420 provides a connection for the RAN 402 to a packet-based network 422. The packet-based network 422 may be the Internet, a private data network, or some other suitable packet-based network. The primary function of the GGSN 420 is to provide the UEs 410 with packet-based network connectivity. Data packets are transferred between the GGSN 420 and the UEs 410 through the SGSN 418, which performs primarily the same functions in the packet-based domain as the MSC 412 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a nodeB 408 and a UE 410, but divides uplink and downlink transmissions into different time slots in the carrier.

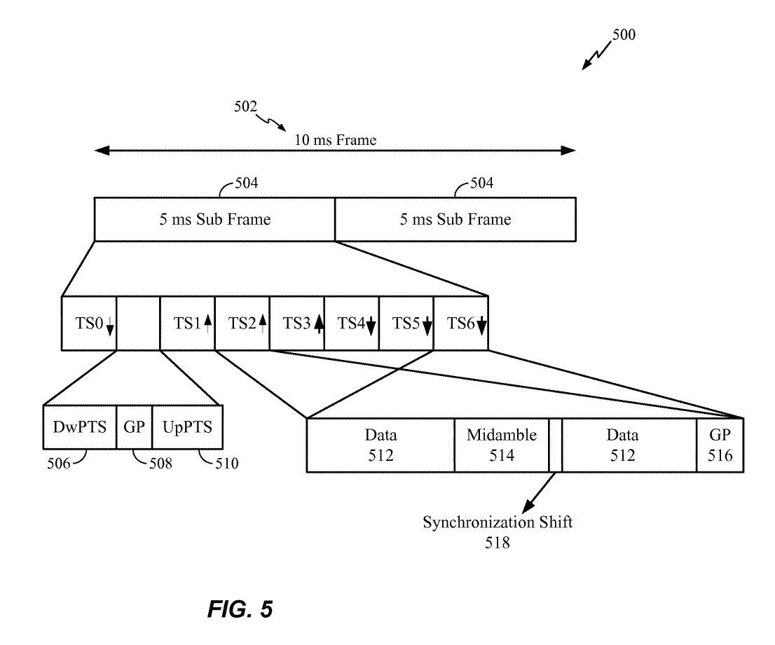

FIG. 5 shows a frame structure 500 for a TD-SCDMA carrier. The TD-SCDMA carrier, as illustrated, has a frame 502 that is 10 ms in length. The chip rate in TD-SCDMA is 1.28 Mcps. The frame 502 has two 5 ms subframes 504, and each of the subframes 504 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 506, a guard period (GP) 508, and an uplink pilot time slot (UpPTS) 510 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 512 (each with a length of 352 chips) separated by a midamble 514 (with a length of 144 chips) and followed by a guard period (GP) 516 (with a length of 16 chips). The midamble 514 may be used for features, such as channel estimation, while the guard period 516 may be used to avoid inter-burst interference. Also transmitted in the data portion is some Layer 1 control information, including synchronization shift (SS) bits 518. Synchronization shift bits 518 only appear in the second part of the data portion. The synchronization shift bits 518 immediately following the midamble can indicate three cases: decrease shift, increase shift, or do nothing in the upload transmit timing. The positions of the synchronization shift bits 518 are not generally used during uplink communications.

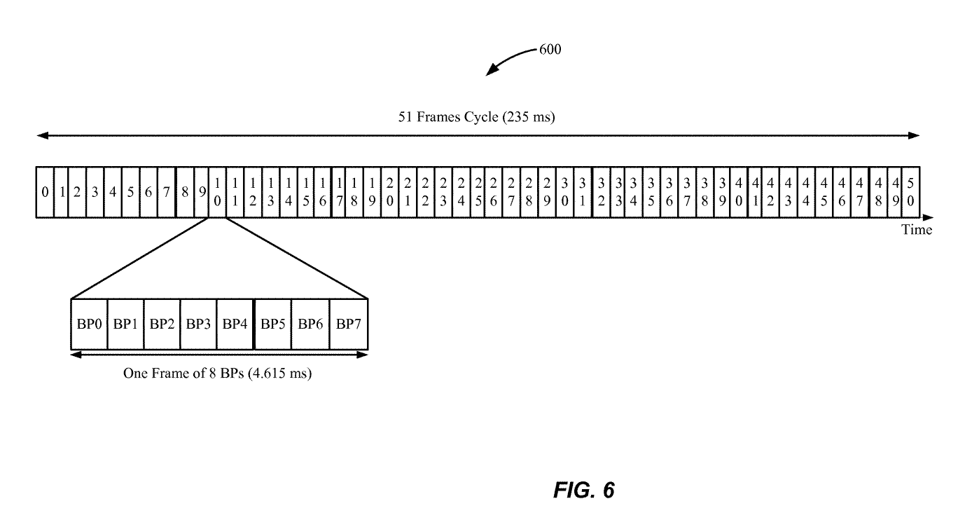

FIG. 6 is a block diagram illustrating an example of a GSM frame structure 600. The GSM frame structure 600 includes fifty-one frame cycles for a total duration of 235 ms. Each frame of the GSM frame structure 600 may have a frame length of 4.615 ms and may include eight burst periods, BP0-BP7.

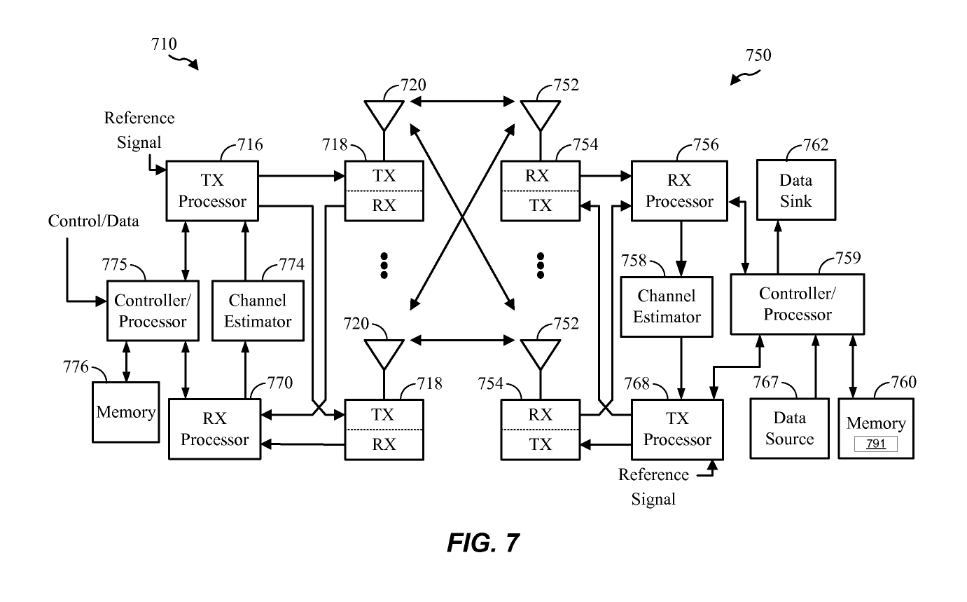

FIG. 7 is a block diagram of a base station (e.g., eNodeB or nodeB) 710 in communication with a UE 750 in an access network. In the downlink, upper layer packets from the core network are provided to a controller/processor 775. The controller/processor 775 implements the functionality of the L2 layer. In the downlink, the controller/processor 775 provides header compression, ciphering, packet segmentation and reordering, multiplexing between logical and transport channels, and radio resource allocations to the UE 750 based on various priority metrics. The controller/processor 775 is also responsible for HARQ operations, retransmission of lost packets, and signaling to the UE 750.

The TX processor 716 implements various signal processing functions for the L1 layer (e.g., physical layer). The signal processing functions includes coding and interleaving to facilitate forward error correction (FEC) at the UE 750 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 774 may be used to determine the coding and modulation scheme, as well as for spatial processing. The channel estimate may be derived from a reference signal and/or channel condition feedback transmitted by the UE 750. Each spatial stream is then provided to a different antenna 720 via a separate transmitter (TX) 718. Each transmitter (TX) 718 modulates a radio frequency (RF) carrier with a respective spatial stream for transmission.

At the UE 750, each receiver (RX) 754 receives a signal through its respective antenna 752. Each receiver (RX) 754 recovers information modulated onto an RF carrier and provides the information to the receiver (RX) processor 756. The RX processor 756 implements various signal processing functions of the L1 layer. The RX processor 756 performs spatial processing on the information to recover any spatial streams destined for the UE 750. If multiple spatial streams are destined for the UE 750, they may be combined by the RX processor 756 into a single OFDM symbol stream. The RX processor 756 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the base station 710. These soft decisions may be based on channel estimates computed by the channel estimator 758. The soft decisions are then decoded and deinterleaved to recover the data and control signals that were originally transmitted by the base station 710 on the physical channel. The data and control signals are then provided to the controller/processor 759.

The controller/processor 759 implements the L2 layer. The controller/processor 759 can be associated with a memory 760 that stores program codes and data. The memory 760 may be referred to as a computer-readable medium. In the uplink, the controller/processor 759 provides demultiplexing between transport and logical channels, packet reassembly, deciphering, header decompression, control signal processing to recover upper layer packets from the core network. The upper layer packets are then provided to a data sink 762, which represents all the protocol layers above the L2 layer. Various control signals may also be provided to the data sink 762 for L3 processing. The controller/processor 759 is also responsible for error detection using an acknowledgement (ACK) and/or negative acknowledgement (NACK) protocol to support HARQ operations.

In the uplink, a data source 767 is used to provide upper layer packets to the controller/processor 759. The data source 767 represents all protocol layers above the L2 layer. Similar to the functionality described in connection with the downlink transmission by the base station 710, the controller/processor 759 implements the L2 layer for the user plane and the control plane by providing header compression, ciphering, packet segmentation and reordering, and multiplexing between logical and transport channels based on radio resource allocations by the base station 710. The controller/processor 759 is also responsible for HARQ operations, retransmission of lost packets, and signaling to the base station 710.

Channel estimates derived by a channel estimator 758 from a reference signal or feedback transmitted by the base station 710 may be used by the TX processor 768 to select the appropriate coding and modulation schemes, and to facilitate spatial processing. The spatial streams generated by the TX processor 768 are provided to different antenna 752 via separate transmitters (TX) 754. Each transmitter (TX) 754 modulates an RF carrier with a respective spatial stream for transmission.

The uplink transmission is processed at the base station 710 in a manner similar to that described in connection with the receiver function at the UE 750. Each receiver (RX) 718 receives a signal through its respective antenna 720. Each receiver (RX) 718 recovers information modulated onto an RF carrier and provides the information to a RX processor 770. The RX processor 770 may implement the L1 layer.

The controller/processor 775 implements the L2 layer. The controller/processor 775 and 759 can be associated with memories 776 and 760, respectively that store program codes and data. For example, the controller/processors 775 and 759 may provide various functions including timing, peripheral interfaces, voltage regulation, power management, and other control functions. The memories 776 and 760 may be referred to as a computer-readable media. For example, the memory 760 of the UE 750 may store a handover module 791 which, when executed by the controller/processor 759, configures the UE 750 to dynamically determine whether to perform synchronized handover.

In the uplink, the controller/processor 775 provides demultiplexing between transport and logical channels, packet reassembly, deciphering, header decompression, control signal processing to recover upper layer packets from the UE 750. Upper layer packets from the controller/processor 775 may be provided to the core network. The controller/processor 775 is also responsible for error detection using an ACK and/or NACK protocol to support HARQ operations.

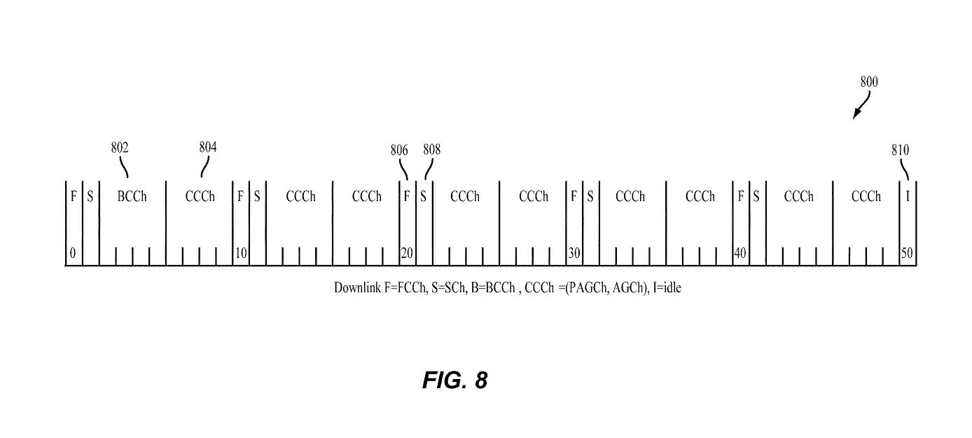

FIG. 8 is a block diagram 800 illustrating the timing of channels according to aspects of the present disclosure. The block diagram 800 shows a broadcast control channel (BCCH) 802, a common control channel (CCCH) 804, a frequency correction channel (FCCH) 806, a synchronization channel (SCH) 808 and an idle time slot 810. The numbers at the bottom of the block diagram 800 indicate various moments in time. In one configuration, the numbers at the bottom of the block diagram 800 are in seconds. Each block of a FCCH 806 may include eight time slots, with only the first timeslot (or TS0) used for FCCH tone detection.

The timing of the channels shown in the block diagram 800 may be determined in a base station identity code (BSIC) identification procedure. The BSIC identification procedure may include detection of the FCCH carrier, based on a fixed bit sequence that is carried on the FCCH 806. FCCH tone detection is performed to find the relative timing between multiple RATs. The FCCH tone detection may be based on the SCH 808 being either a first number of frames or a second number of frames later in time than the FCCH 806. The first number of frames may be equal to 11+n·10 frames and the second number of frames may be equal to 12+n·10 frames. The dot operator represents multiplication and n can be any positive number. These equations are used to schedule idle time slots to decode the SCH. The first number of frames and the second number of frames may be used to schedule idle time slots in order to decode the SCH 808, in case the SCH 808 falls into a measurement gap or an idle time slot 810.

For FCCH tone detection in an inter RAT measurement, the FCCH may fully or partially fall within the idle time slots of the first RAT (not shown). The UE attempts to detect FCCH tones (for example, such as the FCCH 806) on the BCCH carrier of the n strongest BCCH carriers of the cells in the second RAT. The strongest cells in the second RAT may be indicated by a measurement control message. In one configuration, n is eight and the n BCCH carriers are ranked in order of the signal strength. For example, a BCCH carrier may be ranked higher than other BCCH carriers when the signal strength of the BCCH carrier is stronger than the signal strength of the other BCCH carriers. The top ranked BCCH carrier may be prioritized for FCCH tone detection.

Each BCCH carrier may be associated with a neighbor cell in the second RAT. In some instances, the UE receives a neighbor cell list including n ranked neighbor cells from a base station of the first RAT, for example, in a measurement control message. The neighbor cells in the neighbor cell list may be ranked according to signal strength. In some configurations, the n ranked neighbor cells may correspond to the n strongest BCCH carriers, such that system acquisition of the neighbor cells includes FCCH tone detection of these BCCH carriers.

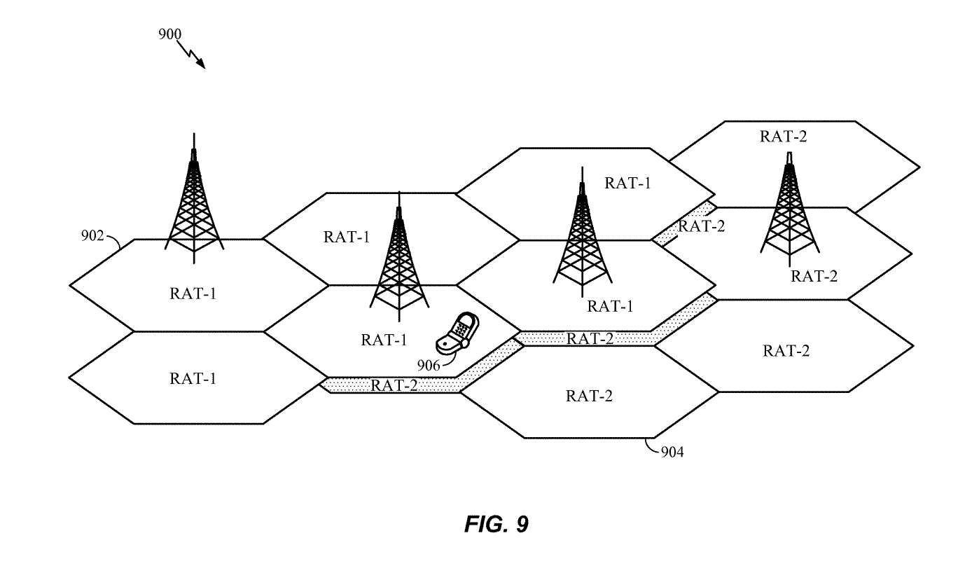

Some networks may be deployed with multiple radio access technologies. FIG. 9 illustrates a network utilizing multiple types of radio access technologies (RATs), such as but not limited to GSM (second generation (2G)), TD-SCDMA (third generation (3G)), LTE (fourth generation (4G)) and fifth generation (5G). Multiple RATs may be deployed in a network to increase capacity. Typically, 2G and 3G are configured with lower priority than 4G. Additionally, multiple frequencies within LTE (4G) may have equal or different priority configurations. Reselection rules are dependent upon defined RAT priorities. Different RATs are not configured with equal priority.

In one example, the geographical area 900 includes RAT-1 cells 902 and RAT-2 cells 904. In one example, the RAT-1 cells are 2G or 3G cells and the RAT-2 cells are LTE cells. However, those skilled in the art will appreciate that other types of radio access technologies may be utilized within the cells. A user equipment (UE) 906 may move from one cell, such as a RAT-1 cell 902, to another cell, such as a RAT-2 cell 904. The movement of the UE 906 may specify a handover or a cell reselection.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

A user equipment (UE) may include more than one subscriber identity module (SIM) or universal subscriber identity module (USIM). A UE with more than one SIM may be referred to as a multi-SIM device. In the present disclosure, a SIM may refer to a SIM or a USIM. Each SIM may also include a unique international mobile subscriber identity (IMSI) and service subscription information. Each SIM may be configured to operate in a particular radio access technology. Moreover, each SIM may have full phone features and be associated with a unique phone number. Therefore, the UE may use each SIM to send and receive phone calls. That is, the UE may simultaneously communicate via the phone numbers associated with each individual SIM. For example, a first SIM card can be associated for use in a City A and a second SIM card may be associated for use in a different City B to reduce roaming fees and long distance calling fees. Alternately, a first SIM card may be assigned for personal usage and a different SIM card may be assigned for work/business purposes. In another configuration, a first SIM card provides full phone features and a different SIM card is utilized mostly for data services.

Many multi-SIM devices support multi-SIM multi-standby operation using multiple radio frequency (RF) chains to transmit and receive communications. An RF chain is a set of components used to communicate between the mobile device and the base station. The UE may also be a multi-SIM multi-standby device, which means the UE is limited to connecting to one network at a time. In one example, a multi-SIM device includes a first SIM dedicated to operate in a first RAT using a first RF chain and a second SIM dedicated to operate in a second RAT using a second RF chain. Alternatively, the first SIM and the second SIM may share a same receive/transmit chain. As a result, communication on the first SIM may be suspended when the UE is in communication with the second SIM. In one illustrative example, the multi-SIM device includes a first SIM configured to operate in fourth generation (4G) radio access technology (RAT) (e.g., LTE) and a second SIM configured to operate in a second/third generation (2G/3G) RAT. The multi-SIM device may operate in other RATS known to those skilled in the art.

When a fourth generation radio access technology subscription is in a radio resource control (RRC) connected mode without voice traffic, the dual subscriber identity module dual standby UE supports tuning away from a connected RAT for various purposes, including neighbor cell measurement, etc. The UE may attempt to schedule the tuning away to reduce the impact to ongoing communications. For example, the UE may tune away from the fourth generation RAT to the second/third generation RAT while trying to reduce the amount of interruption to the fourth generation connected mode operation. As an example of the UE tuning away to check a neighboring RAT's signal, a multi-SIM, multi-standby UE may periodically tune away from LTE to perform one or more communication activities on TD-SCDMA or GSM. The TD-SCDMA communication activities may include monitoring for a page, collecting broadcast control channel (BCCH) system information blocks (SIBs), performing cell reselection, etc. If a page is detected when the UE is tuned to TD-SCDMA, the UE suspends LTE operations and transitions to TD-SCDMA. When a page is not detected on the second/third generation RAT, the UE tunes back or attempts to tune back to the fourth generation RAT and attempts to recover the original operation of the fourth generation RAT.

Ongoing communication on the UE may be handed over from the first RAT to a second RAT based on measurements performed on the second RAT. For example, the UE may tune away to the second RAT to perform the measurements. Examples of ongoing communications on the UE include communications according to a single radio voice call continuity (SRVCC) procedure. SRVCC is a solution aimed at providing continuous voice services on packet-switched networks (e.g., LTE networks). In the early phases of LTE deployment, when UEs running voice services move out of an LTE network, the voice services can continue in the legacy circuit-switched (CS) domain using SRVCC, ensuring voice service continuity. SRVCC is a method of inter-radio access technology (IRAT) handover. SRVCC enables smooth session transfers from voice over internet protocol (VoIP) over the IP multimedia subsystem (IMS) on the LTE network to circuit-switched services in the universal terrestrial radio access network (UTRAN) or GSM enhanced date rates for GSM Evolution (EDGE) radio access network (GERAN).

LTE coverage is limited in availability. When a UE that is conducting a packet-switched voice call (e.g., voice over LTE (VoLTE) call) leaves LTE coverage or when the LTE network is highly loaded, SRVCC may be used to maintain voice call continuity from a packet-switched (PS) call to a circuit-switched call during IRAT handover scenarios. SRVCC may also be used, for example, when a UE has a circuit-switched voice preference (e.g., circuit-switched fallback (CSFB)) and packet-switched voice preference is secondary if combined attach fails. The evolved packet core (EPC) may send an accept message for packet-switched attach in which case a VoIP/IMS capable UE initiates a packet-switched voice call.

A UE may perform an LTE serving cell measurement. When the LTE serving cell signal strength or quality is below a threshold (meaning the LTE signal may not be sufficient for an ongoing call), the UE may report an event 2A (change of the best frequency). In response to the measurement report, the LTE network may send radio resource control (RRC) reconfiguration messages indicating 2G/3G neighbor frequencies. The RRC reconfiguration message also indicates event B1 (neighbor cell becomes better than an absolute threshold) and/or B2 (a serving RAT becomes worse than a threshold and the inter-RAT neighbor become better than another threshold). The LTE network may also allocate LTE measurement gaps. For example, the measurement gap for LTE is a 6 ms gap that occurs every 40 or 80 ms. The UE uses the measurement gap to perform 2G/3G measurements and LTE inter frequency measurements.

The measurement gap may be used for multiple IRAT measurements and inter frequency measurements. The inter frequency measurements may include measurements of frequencies of a same RAT (e.g., serving LTE). The IRAT measurements may include measurements of frequencies of a different RAT (e.g., non-serving RAT such as TD-SCDMA or GSM). In some implementations, the LTE inter frequency measurements and TD-SCDMA IRAT measurements have a higher measurement scheduling priority than GSM.

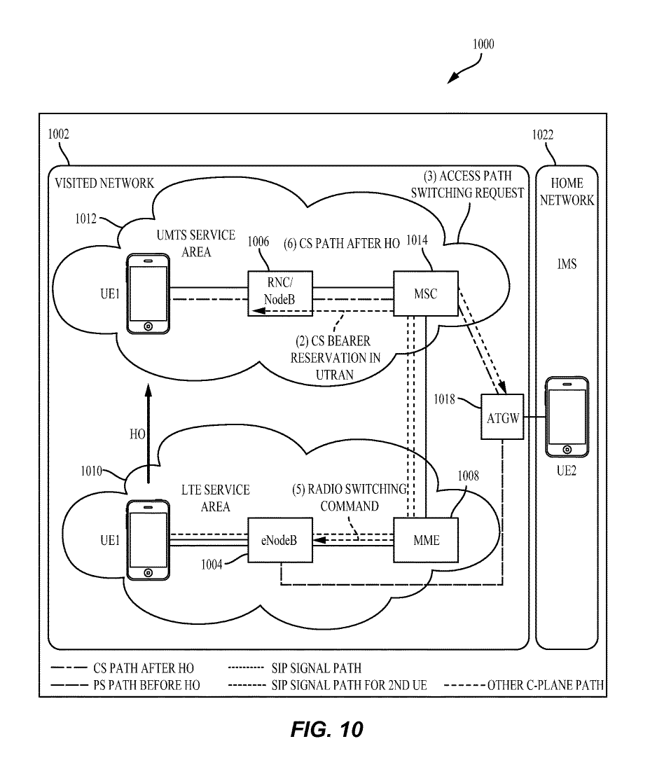

When the LTE eNodeB receives the event B1 report from the UE, the LTE eNodeB may initiate the SRVCC procedure. The SRVCC procedure may be implemented in a wireless network, such as the wireless network of FIG. 10.

FIG. 10 is a block diagram illustrating a wireless communication network 1000 in accordance with aspects of the present disclosure. Referring to FIG. 10, the wireless communication network 1000 may include a visited network 1002 and a home network 1022. The visited network 1002 may include multiple service areas. For example, as shown in FIG. 10, without limitation, the visited network 1002 may include an LTE service area 1010 and a UMTS service area 1012. A first UE (UE1) located in the LTE service area 1010 may conduct a voice call with a second UE (UE2), which is located in the home network 1022. In one aspect, UE1 may conduct a voice call (e.g., a PS call or VoLTE) with UE2 via the access transfer gateway (ATGW) 1018.

When UE1 leaves the LTE service area 1010, the LTE serving cell (eNodeB 1004) signal strength or signal quality may fall below a threshold. As such, UE1 may report an event 2A. In turn, the eNodeB 1004 may provide an RRC connection reconfiguration message to UE1. The RRC connection reconfiguration message may include measurement configuration information such as the LTE measurement gap allocation. For example, the LTE gap allocation may be such that a 6 ms measurement gap occurs every 40 ms.

Accordingly, UE1 may conduct the IRAT and inter-frequency measurements and provide a corresponding measurement report to the eNodeB 1004, which may initiate the handover of coverage to the NodeB 1006 of the UMTS service area 1012. The mobility management entity (MME) 1008 may initiate an SRVCC procedure for the handover. A switch procedure may be initiated to transfer the voice call to a circuit-switched network. An access path switching request is sent via the mobile switching center (MSC) 1014, which routes the voice call to UE2 via the access transfer gateway (ATGW) 1018. Thereafter, the call between UE1 and UE2 may be transferred to a circuit-switched call. The various communication links or paths are represented by solid and different dashed lines. The communication paths include circuit-switched (CS) path after handover (HO), packet-switched path before handover, session initiation protocol (SIP) signal path, session initiation protocol signal path for a second UE (UE2) and a communication plane (C-plane) path.

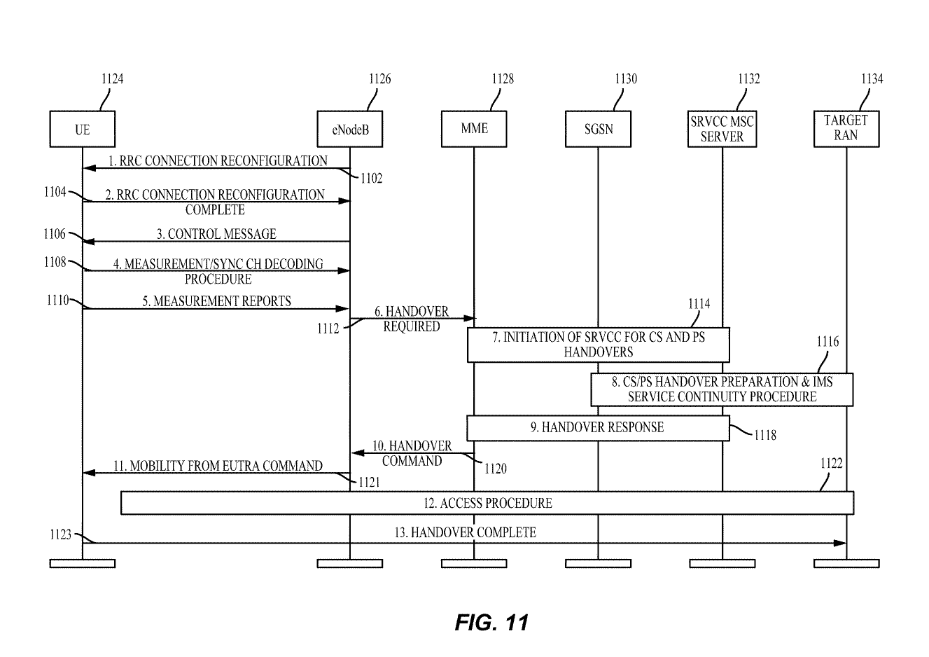

FIG. 11 is an exemplary call flow diagram illustrating a signaling procedure for handover of a UE communicating according to a single radio voice call continuity (SRVCC) procedure. At time 1102, an eNodeB 1126 sends an RRC connection reconfiguration message to a UE 1124. The RRC connection configuration message may include the measurement configuration with information about the measurement gap resources.

At time 1104, the UE 1124 sends a message to the eNodeB 1126 indicating that RRC connection reconfiguration is complete. At time 1106, the UE 1124 receives a control message (e.g., measurement control message) from the eNodeB 1126. The measurement control message (MCM) may identify neighbor cells (e.g., GSM neighbor cells) and IRAT measurement report triggering conditions of the neighbor cells to trigger an IRAT measurement report.

At time 1108, the UE performs a measurement procedure on the neighbor cell(s). The measurement procedure may be performed periodically. The measurement procedure includes inter radio access technology (IRAT) and/or inter frequency measurements as well as a base station identity code (BSIC) procedure (or synchronization channel decoding procedure). For example, the measurements include signal quality (e.g., received signal strength indicator (RSSI)) measurements for neighbor cells/frequencies, such as all GSM frequencies. The IRAT and/or inter frequency measurements also include LTE inter-frequency measurements, third generation (3G) measurements such as UMTS (e.g., TD-SCDMA) measurements, GSM measurements, etc. The synchronization channel decoding procedure includes tone detection (e.g., frequency correction channel (FCCH) tone detection) and synchronization channel (SCH) decoding that are performed after the signal quality measurements. The UE 1124 uses a measurement gap (e.g., 6 ms gap for LTE) to perform the signal quality measurements and the synchronization channel decoding procedure. The synchronization channel decoding procedure may be performed after the signal quality measurements to identify target cells (e.g., obtain GSM cell identification) and to synchronize (e.g., using obtained GSM cell timing) the UE with target cells (e.g., target GSM cells). For example, the synchronization channel decoding procedure may be performed on a selected cell and/or after the UE moves to the target cell (e.g., a target cell with the best signal quality measurement).

In addition, at time 1110, the UE 1124 sends a measurement report to the eNodeB 1126. For example, the IRAT measurement report may be sent when the IRAT measurement report triggering conditions are satisfied. The eNodeB 1126 provides an indication of whether handover is desirable to the mobility management entity (MME) 1128 at time 1112. In turn, at time 1114, the MME 1128 initiates SRVCC for circuit switched (CS) and packet switched (PS) handovers. At time 1116, a serving GPRS support node (SGSN) 1130 begins CS/PS handover preparation and IMS service continuity procedures. At time 1118, the SRVCC MSC server 1132 sends a handover response message to the MME 1128. At time 1120, the MME sends a message to the eNodeB 1126 including a handover command. At time 1121, the eNodeB 1126 provides a mobility from EUTRA command (e.g., handover command) to the UE 1124. The handover command includes information (e.g., random access information) for the UE 1124 to setup a call at the target cell. At time 1122, the UE 1124 initiates an access procedure (e.g., random access procedure). At time 1123, a handover complete message is sent to the target radio access network (RAN) 1134.

Conventional handover procedures specify that the synchronization channel decoding procedure may be performed during one or more time periods of the signaling procedure. For example, a first synchronization channel decoding procedure may occur at a first time (e.g., time 1108) during the measurement procedures. A second synchronization channel decoding procedure may occur after a handover command. The synchronization channel decoding procedures may be performed in accordance with a synchronized handover. For example, the UE performs the first synchronization channel decoding procedure after the UE sends the message indicating the RRC connection reconfiguration is complete and the second synchronization channel decoding procedure after reception of the handover command (e.g., EUTRAN handover command). The multiple synchronization channel decoding procedures may be performed to improve a success rate of the handover procedure. For example, although GSM cell timing obtained from the first synchronization channel decoding procedure can be used to synchronize the UE to the target RAT, an updated GSM cell timing that is more reliable may be subsequently obtained from the second synchronization channel decoding procedure. The more reliable GSM cell timing may improve the reliability of the handover to the target RAT.

According to the conventional handover procedures, after the UE receives the handover command, the UE is specified either to perform the second synchronization channel decoding procedure all the time or not to perform the second synchronization channel decoding procedure at all. That is, the UE is either configured to perform the synchronization channel decoding procedures or not. These conventional configurations of the UE, however, are static, increase latency of the handover procedure and increase voice/data interrupt time. For example, the increased latency may prevent the UE from meeting a latency specification (e.g., voice and/or data interrupt time such as 300 ms) when the UE transitions from a packet switched (e.g., voice over internet protocol (VOIP)) voice call to a 2G (e.g., GSM) or 3G (e.g., UMTS) voice call.

### Dynamic Handover Synchronization

In one aspect of the disclosure, a user equipment (UE) dynamically determines whether to perform a synchronization channel decoding procedure for synchronized handover on target cell(s) after receiving a handover command from one or more serving cells of a first radio access technology (RAT) to handover to a second RAT. The procedure for dynamically determining includes determining whether a communication condition is satisfied. The dynamically determining procedure also includes determining whether to perform the synchronization channel decoding procedure for a synchronized handover to a second radio access technology (RAT) after receiving the handover command from one or more serving cells of the first RAT based on whether the communication condition is satisfied.

The synchronization channel decoding procedure includes tone detection (e.g., frequency correction channel (FCCH) tone detection) and synchronization channel (SCH) decoding. The synchronization channel decoding procedure after the command may be a second synchronization channel decoding procedure. The second synchronization channel decoding procedure may occur subsequent to a first synchronization channel decoding procedure that occurs before the handover command is received by the UE. For example, the second synchronization channel decoding procedure may be performed after the UE moves to a target cell in response to receiving a handover command. When the UE performs the second synchronization channel decoding procedure, latency and data interrupt times are increased. However, throughput of the handover procedure is improved because of the second synchronization channel decoding procedure on the target cell. For example, the UE may obtain an updated GSM timing from the second synchronization channel decoding procedure that improves the synchronization of the UE with the target cell. Because the UE performs the synchronization channel decoding procedure twice, the GSM timing is more reliable.

Alternatively, the UE may decide to directly perform a random access procedure after the handover command rather than performing the synchronized handover. For example, the UE performs a non-synchronized handover after receiving the handover command. When the UE performs the non-synchronized handover (e.g., the UE does not perform the second synchronization channel decoding procedure) after the UE moves to the target cell, the latency and data/voice interrupt times are reduced while the handover throughput deteriorates. For example, the throughput deteriorates if the target cell downlink timing obtained from the synchronization channel decoding procedure changed. In this case, the UE may not synchronize with the target cell. To improve the throughput and latency during the handover, the UE may dynamically determine whether to perform the synchronized handover or the non-synchronized handover after receiving the handover command. The determination may be based on whether certain wireless communication conditions (e.g., whether the target cell timing changed after the first synchronization channel decoding procedure) are satisfied.

One of the conditions includes a quality of service (QoS) specification. For example, the quality of service specification may include an indicator such as a quality of service class indicator (QCI). In one aspect, the UE may determine whether to perform the second synchronization channel decoding procedure based on a priority (e.g., highest priority) of the QCI. For example, each communication link (e.g., channel) is prioritized by parameters such as a function of the average rate at which the UE has been served in the past, a queue length (number of bytes/packets in buffer), and an head-of-line packet delay (e.g., the current time minus the time the oldest packet arrived in the queue). Such parameters may be derived from the QCI (quality of service (QoS) class identifier). Some networks include quality classes (e.g., QCI classes) to deliver specific service quality for specific traffic types. Different traffic types such as video, voice, and data have different service quality indicators, which will enable network components to treat these traffic types differently while traffic is passing through them. Some of the service quality indicators include data transmission delay (e.g., latency), minimum bit rate and aggregated bit rate. Thus, the UE may not perform the second synchronization channel decoding procedure to meet reduced transmission delay specifications.

In another aspect of the disclosure, the UE determines whether to perform the second synchronization channel decoding procedure based on a change in path loss, a measured Doppler frequency and/or the UE speed. For example, the UE performs the second synchronization channel decoding procedure when a change in the path loss is greater than a path loss threshold, when the measured Doppler frequency is greater than a frequency threshold and/or when the UE speed is greater than a speed threshold. Path loss is a reduction of power density or the attenuation of a signal as it propagates through space or any communications medium. Thus, path loss corresponds to distance: the higher the path loss, the greater the distance between the transmitter and receiver. For example, the UE location dictates the path loss between the UE and the serving cell as well as between the UE and the neighbor cells. In one aspect, each of the thresholds may be independently defined by the UE. The UE speed may be indicated by a GPS system, the Doppler frequency measurement or in another way. Doppler frequency may be determined based on data symbols, pilot symbols, or any combination of appropriate symbols received by the UE.

In yet another aspect of the disclosure, the UE determines whether to perform the second synchronization channel decoding procedure based on an uplink timing change indicated by timing advance (TA) commands. The uplink timing change may be indicated before the UE receives the handover command. For example, the UE performs the second synchronization channel decoding procedure when the uplink timing change indicated by the timing advance commands exceeds a timing change threshold. In one aspect, the timing change threshold may be independently defined by the UE.

In a further aspect of the disclosure, the UE determines whether to perform the second synchronization channel decoding procedure based on a latency specification for an application running on the UE and/or a handover preparation time (e.g., time from when the UE sends the measurement report until UE receives the handover command.) For example, the UE performs the second synchronization channel decoding procedure when the latency specification for an application running on the UE is below a latency threshold and/or when the handover preparation time exceeds a time threshold. Each of the thresholds may be independently defined by the UE.

The UE may also determine whether to perform the second synchronization channel decoding procedure based on a signal quality of the second RAT of a synchronization channel and/or based on a frequency correction channel/synchronization channel signal-to-noise ratio measured during an IRAT measurement gap (e.g., LTE measurement gap). For example, the UE performs the second synchronization channel decoding procedure when the signal quality of the second RAT is below a signal quality threshold and/or when the signal-to-noise ratio meets a signal-to-noise threshold. Each of the thresholds may be independently defined by the UE.

Furthermore, the UE determines whether to perform the second synchronization channel decoding procedure based on an indication from a serving cell of the first RAT and/or an indication from a target cell of the second RAT. The indication may be included in a dedicated signaling message and/or a broadcast system information message. For example, the UE performs the second synchronization channel decoding procedure when the serving cell of the first RAT and/or the target cell of the second RAT indicate a high speed flag in the message. The high speed flag indicates when a cell is expected to serve the UE in high speed (e.g., when the UE is in a high speed train).

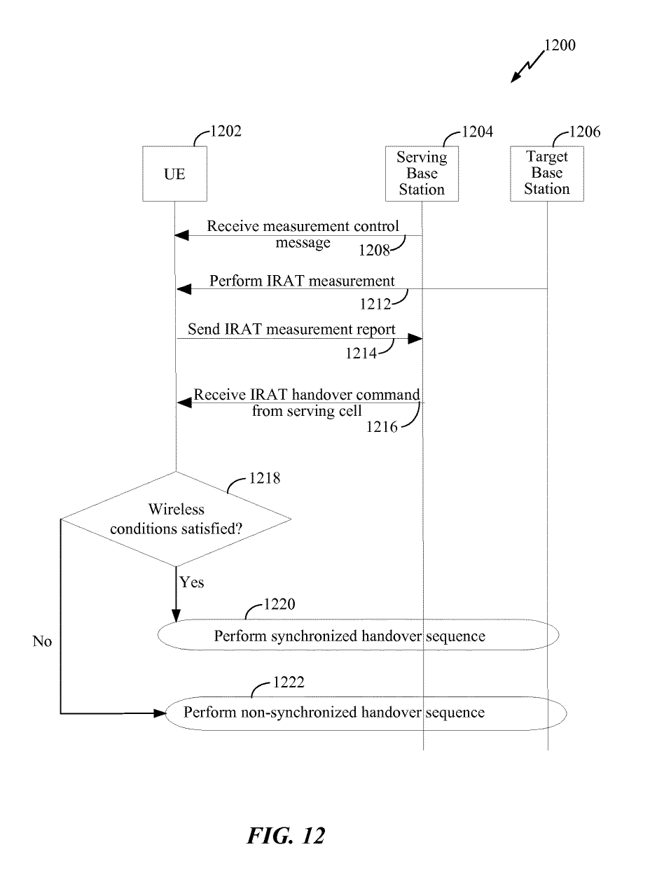

FIG. 12 is a call flow diagram of a handover procedure according to aspects of the present disclosure. A UE 1202 may be handed over from a serving base station (BS) 1204 (e.g., eNodeB 1126 of FIG. 11) to a target base station 1206 of a target radio access network (RAN) (e.g., target RAN 1134 of FIG. 11). The handover operations include receiving a control message (e.g., measurement control message), at time 1208, from the serving base station 1204. In a CoMP (cooperative multipoint) configuration, the message may be received from multiple base stations. The measurement control message (MCM) may identify neighbor cells (e.g., GSM neighbor cells). The measurement control message may also include IRAT measurement report triggering conditions of the neighbor cells for triggering an IRAT measurement report. The identified neighbor cells (e.g., target GSM cells supported by the target base station 1206) may be included in a neighbor list associated with the control message.

The UE 1202 performs IRAT measurements of the neighbor cells, at time 1212, in response to receiving the measurement control message. The UE 1202 sends the result of the measurements in an IRAT measurement report to the serving base station(s) 1204, at time 1214. The IRAT measurement report includes a list of the neighbor cells that meet the IRAT measurement report triggering conditions. The IRAT measurement report triggering conditions may correspond to a measurement threshold, such as a signal quality threshold. For example, the IRAT measurement report may include a list of the GSM neighbor cells that meet the signal quality threshold.

At time 1216, the UE 1202 receives an IRAT handover command from the serving base station(s) 1204. After the handover command is received, the UE 1202 dynamically determines whether to perform the synchronized handover or a non-synchronized handover to target cell(s) of the target base station 1206, at time 1218. For example, the UE 1202 dynamically determines whether to perform the second synchronization channel decoding procedure. As noted, the determination may be based on whether certain wireless communication conditions are satisfied, as shown at time 1218. When the conditions are satisfied, the UE 1202 performs the handover sequence according to the synchronized handover specifications (e.g., the UE performs the second synchronization channel decoding procedure), at time 1220. Otherwise, when the wireless conditions are not satisfied, the UE 1202 performs the handover sequence according to a non-synchronized handover specification (e.g., the UE does not perform the second synchronization channel decoding procedure), at time 1222.

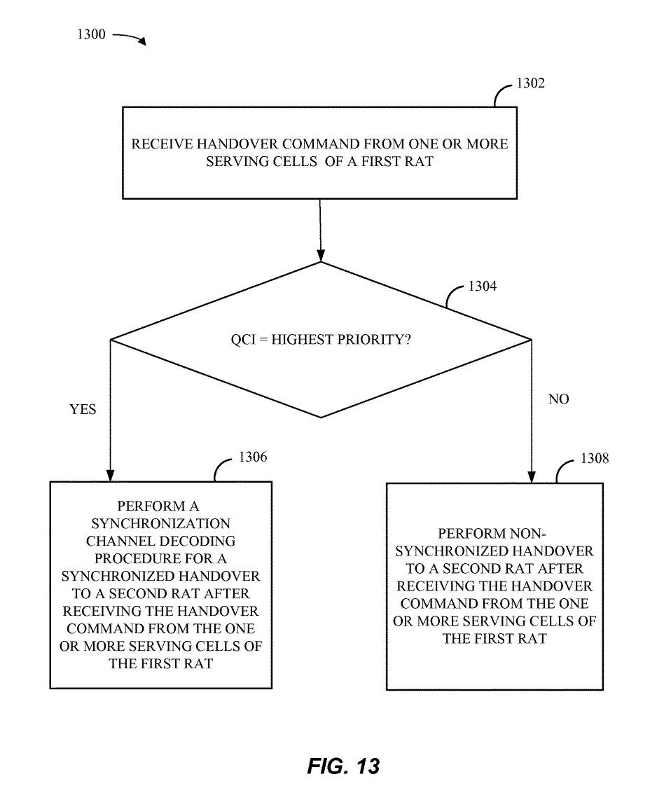

FIGS. 13-21 are diagrams of handover procedures including examples of the wireless communication conditions according to aspects of the present disclosure.

Referring to FIG. 13, the handover procedure 1300 starts by receiving a handover command, at block 1302, from one or more serving cells of a first RAT. As noted, the handover command includes information (e.g., random access information) for the UE to set up a call at a target cell. After receiving the handover command, the UE determines whether a wireless communication condition is satisfied. For example, at block 1304, the UE determines whether the priority of the quality of service class indicator (QCI) is the highest priority. When the quality of service class indicator is the highest priority, the UE performs the synchronization channel decoding procedure for the synchronized handover, at block 1306. Otherwise, when the quality of service class indicator is not the highest priority, the UE performs the non-synchronized handover after receiving the handover command, at block 1308.

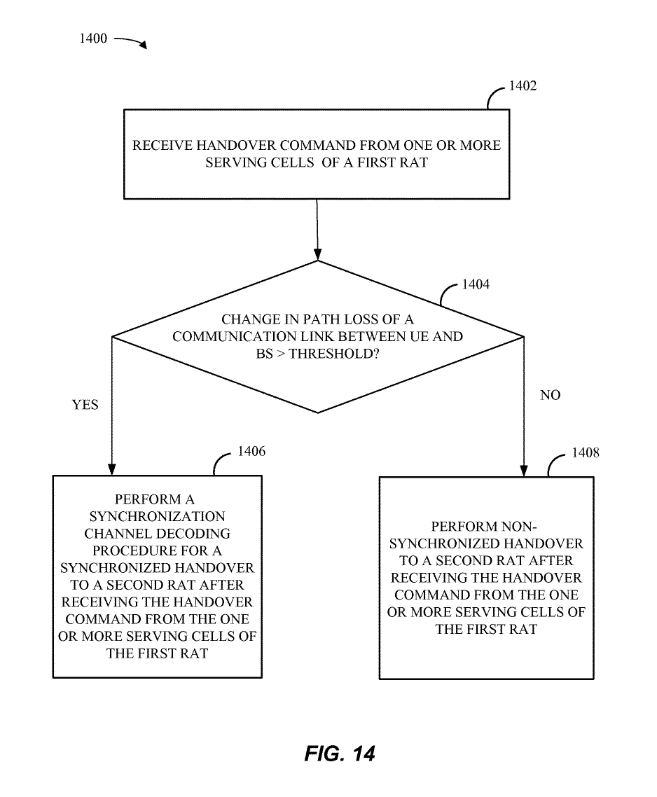

Referring to FIG. 14, the handover procedure 1400 starts by receiving a handover command, at block 1402, from one or more serving cells of a first RAT. After receiving the handover command, the UE determines whether a wireless communication condition is satisfied. For example, at block 1404, the UE determines whether a change in path loss of a communication link between the UE and a base station is greater than a threshold. When the change in the path loss of the communication link is greater than the threshold, the UE performs the synchronization channel decoding procedure for the synchronized handover, at block 1406. Otherwise, when the change in the path loss of the communication link is not greater than the threshold, the UE performs the non-synchronized handover after receiving the handover command, at block 1408.

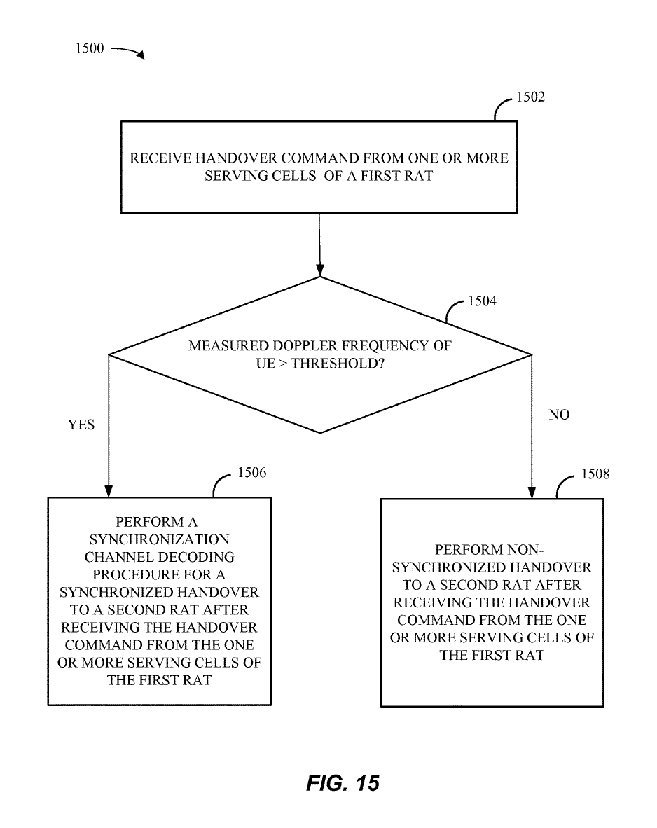

Referring to FIG. 15, the handover procedure 1500 starts by receiving a handover command, at block 1502, from one or more serving cells of a first RAT. After receiving the handover command, the UE determines whether a wireless communication condition is satisfied. For example, at block 1504, the UE determines whether a measured Doppler frequency of the UE is greater than a threshold. When the measured Doppler frequency of the UE is greater than the threshold, the UE performs the synchronization channel decoding procedure for the synchronized handover, at block 1506. Otherwise, when the measured Doppler frequency of the UE is not greater than the threshold, the UE performs the non-synchronized handover after receiving the handover command, at block 1508.

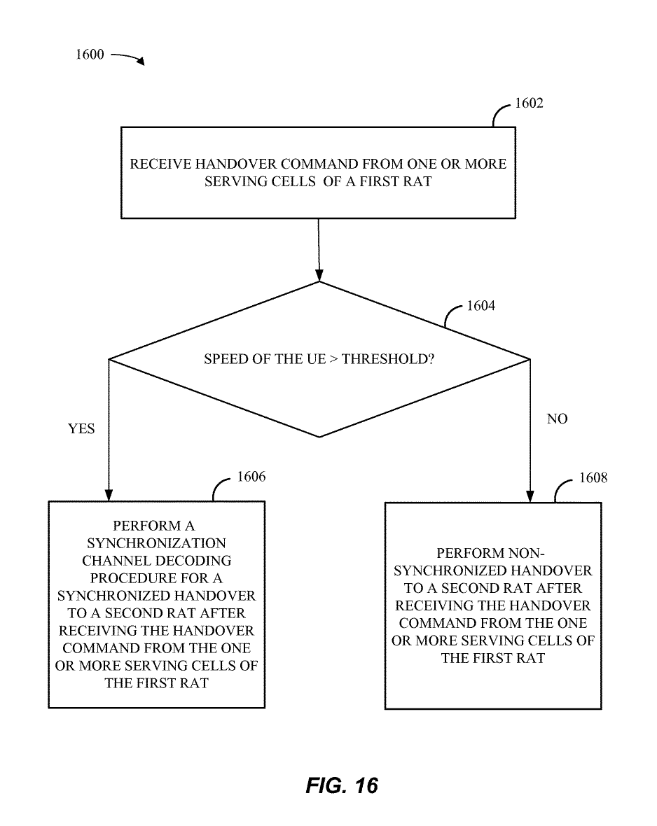

Referring to FIG. 16, the handover procedure 1600 starts by receiving a handover command, at block 1602, from one or more serving cells of a first RAT. After receiving the handover command, the UE determines whether a wireless communication condition is satisfied. For example, at block 1604, the UE determines whether a speed of the UE is greater than a threshold. When the speed of the UE is greater than the threshold, the UE performs the synchronization channel decoding procedure for the synchronized handover, at block 1606. Otherwise, when the speed of the UE is not greater than the threshold, the UE performs the non-synchronized handover after receiving the handover command, at block 1608.

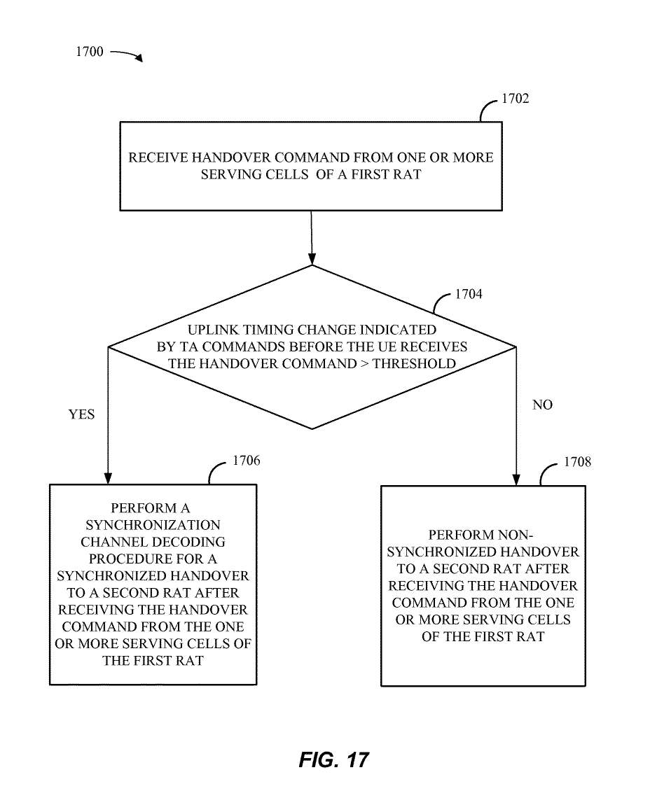

Referring to FIG. 17, the handover procedure 1700 starts by receiving a handover command, at block 1702, from one or more serving cells of a first RAT. After receiving the handover command, the UE determines whether a wireless communication condition is satisfied. For example, at block 1704, the UE determines whether an uplink timing change indicated by timing advance (TA) commands exceeds a threshold before the UE receives the handover command. When the uplink timing change indicated by the timing advance commands exceeds the threshold before the UE receives the handover command, the UE performs the synchronization channel decoding procedure for the synchronized handover, at block 1706. Otherwise, when the uplink timing change indicated by the timing advance commands does not exceed the threshold before the UE receives the handover command, the UE performs the non-synchronized handover after receiving the handover command, at block 1708.

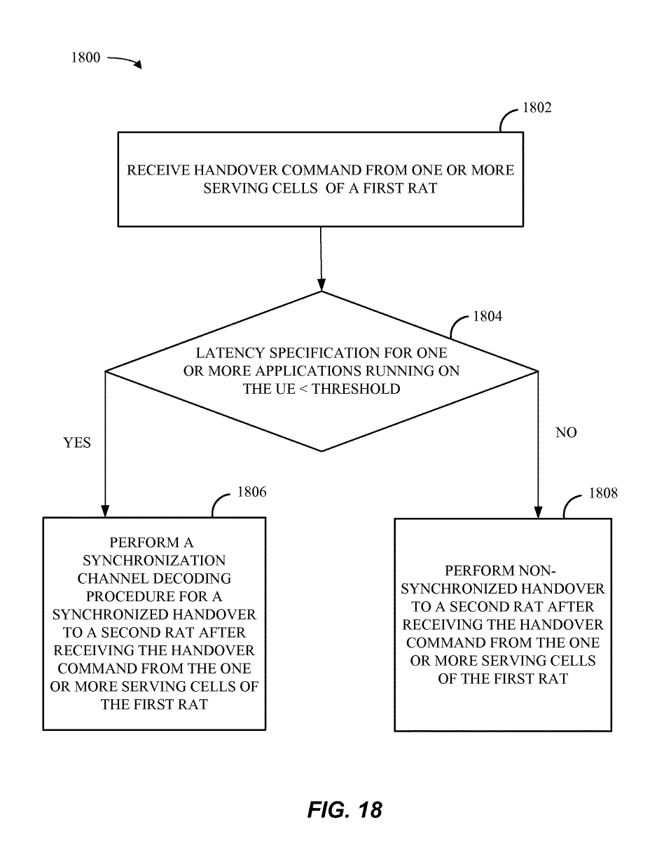

Referring to FIG. 18, the handover procedure 1800 starts by receiving a handover command, at block 1802, from one or more serving cells of a first RAT. After receiving the handover command, the UE determines whether a wireless communication condition is satisfied. For example, at block 1804, the UE determines whether a latency specification for one or more applications running on the UE is below a threshold. When the latency specification for the one or more applications running on the UE is below the threshold, the UE performs the synchronization channel decoding procedure for the synchronized handover, at block 1806. Otherwise, when the latency specification for the one or more applications running on the UE is not below the threshold, the UE performs the non-synchronized handover after receiving the handover command, at block 1808.

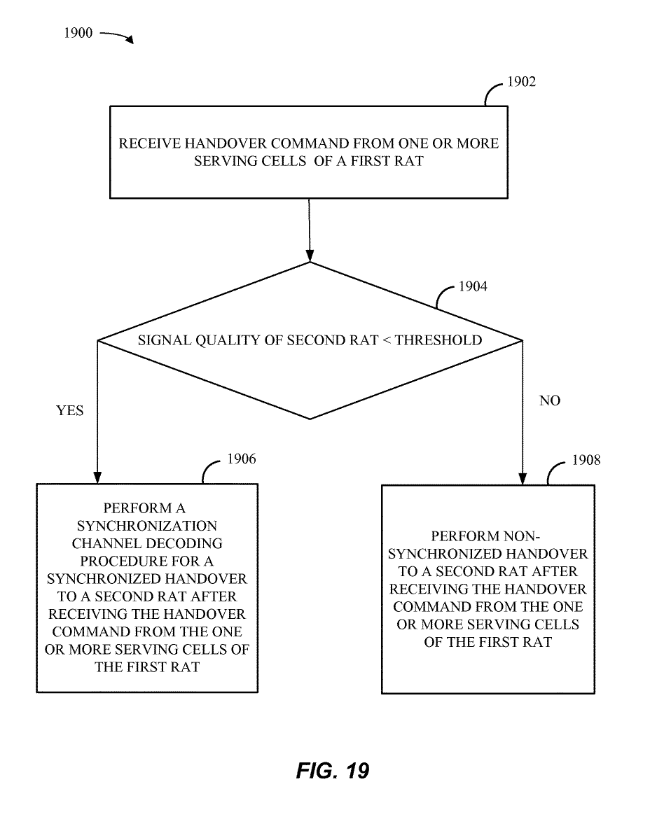

Referring to FIG. 19, the handover procedure 1900 starts by receiving a handover command, at block 1902, from one or more serving cells of a first RAT. After receiving the handover command, the UE determines whether a wireless communication condition is satisfied. For example, at block 1904, the UE determines whether a signal quality of the second RAT is below a threshold. When the signal quality of the second RAT is below the threshold, the UE performs the synchronization channel decoding procedure for the synchronized handover, at block 1906. Otherwise, when the signal quality of the second RAT is not below the threshold, the UE performs the non-synchronized handover after receiving the handover command, at block 1908.

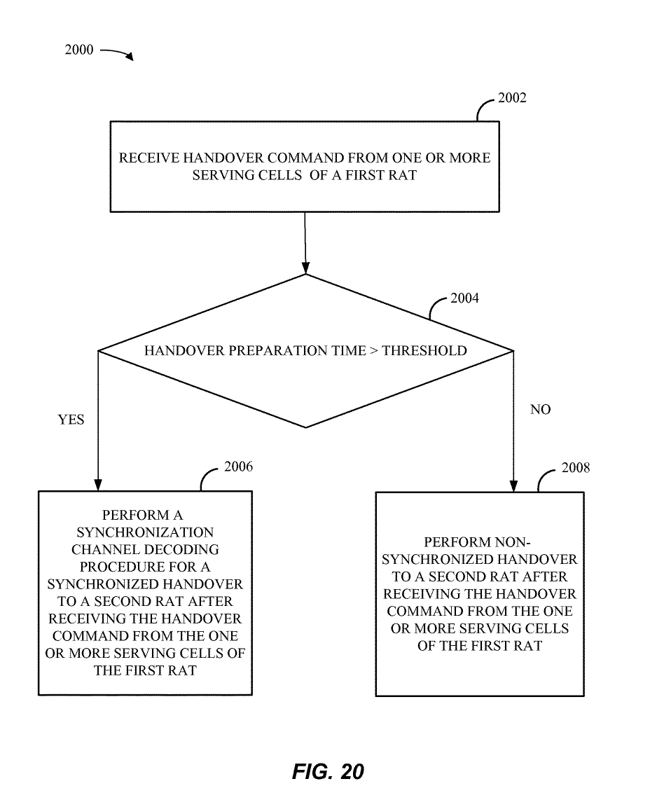

Referring to FIG. 20, the handover procedure 2000 starts by receiving a handover command, at block 2002, from one or more serving cells of a first RAT. After receiving the handover command, the UE determines whether a wireless communication condition is satisfied. For example, at block 2004, the UE determines whether a handover preparation time exceeds a threshold. When the handover preparation time exceeds the threshold, the UE performs the synchronization channel decoding procedure for the synchronized handover, at block 2006. Otherwise, when the handover preparation time does not exceed the threshold, the UE performs the non-synchronized handover after receiving the handover command, at block 2008.

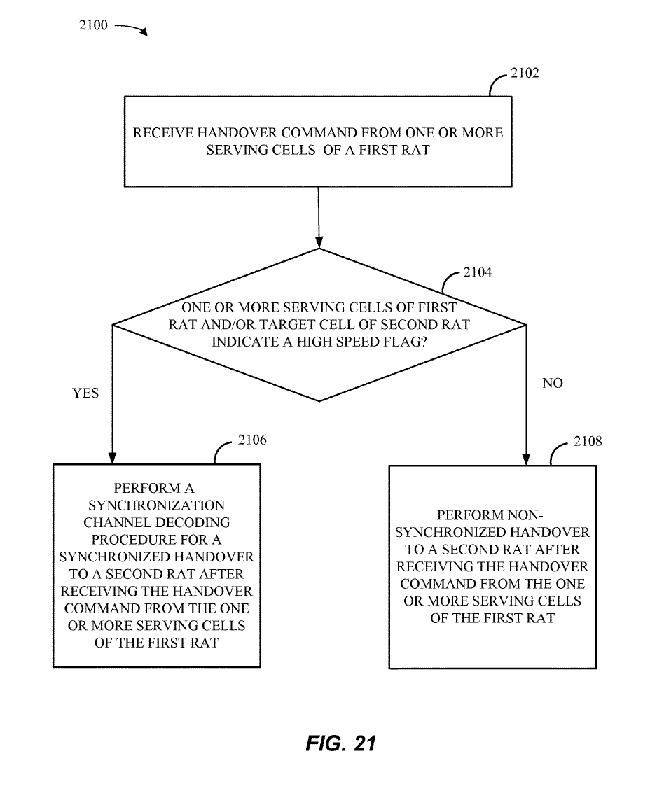

Referring to FIG. 21, the handover procedure 2100 starts by receiving a handover command, at block 2102, from one or more serving cells of a first RAT. After receiving the handover command, the UE determines whether a wireless communication condition is satisfied. For example, at block 2104, the UE determines whether the one or more serving cells of the first RAT and/or the target cell of the second RAT indicate a high speed flag in a dedicated signaling message and/or a broadcast system information message. When the one or more serving cells of the first RAT and/or the target cell of the second RAT indicate the high speed flag in the dedicated signaling message and/or the broadcast system information message, the UE performs the synchronization channel decoding procedure for the synchronized handover, at block 2106. Otherwise, when the one or more serving cells of the first RAT and/or the target cell of the second RAT does not indicate the high speed flag in the dedicated signaling message and/or the broadcast system information message, the UE performs the non-synchronized handover after receiving the handover command, at block 2108.

Aspects of the present disclosure improve handover throughput. For example, communication interruptions are reduced during a handover transition, such as single radio-voice call continuity (SRVCC) handover transitions.

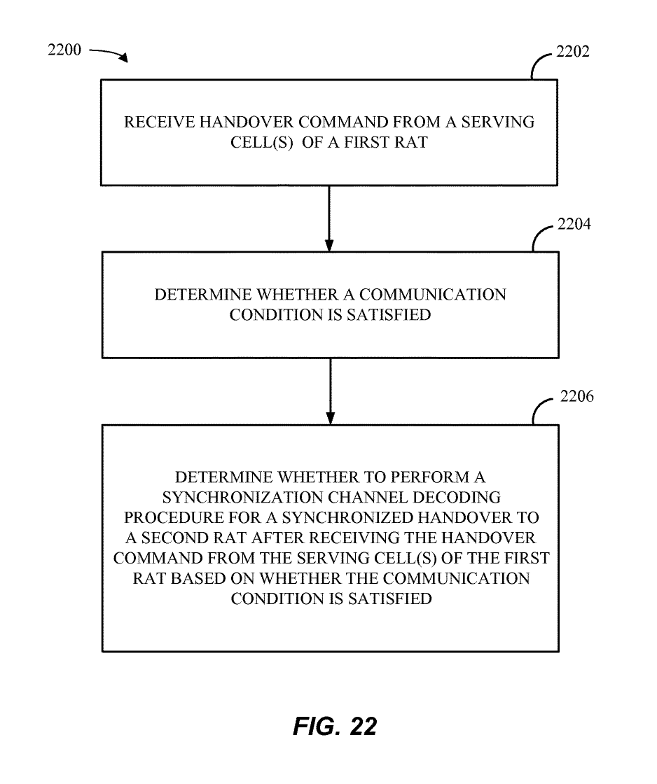

FIG. 22 shows a wireless communication method 2200 according to one aspect of the disclosure. At block 2202, a user equipment (UE) receives a handover command from one or more serving cells of a first RAT. At block 2204, the UE determines whether a communication condition is satisfied. At block 2206, the UE determines whether to perform a synchronization channel decoding procedure for a synchronized handover to a second radio access technology (RAT) after receiving the handover command from one or more serving cells of the first RAT based on whether the communication condition is satisfied. The synchronization channel decoding procedure includes frequency correction channel (FCCH) tone detection and/or synchronization channel (SCH) decoding after the UE transitions to a target cell of the second RAT.

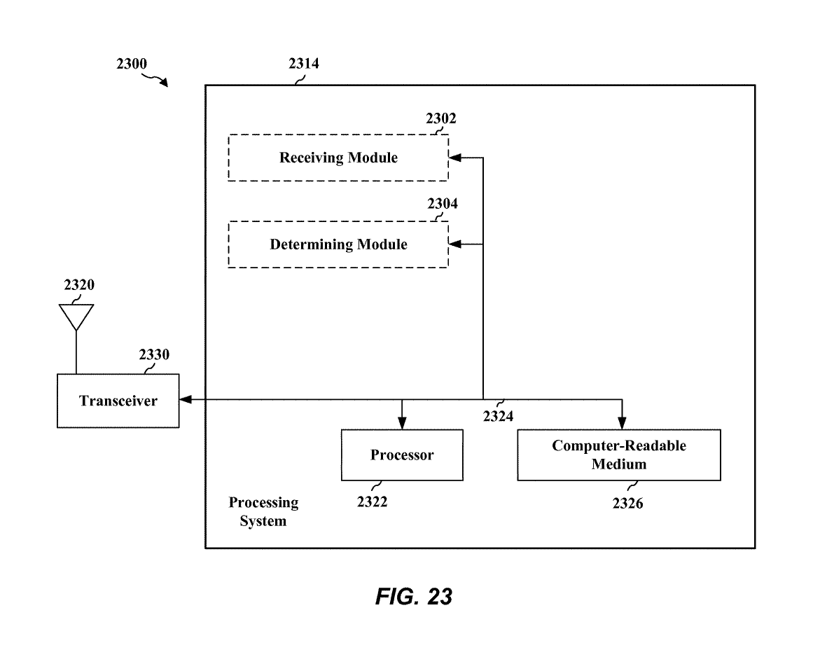

FIG. 23 is a diagram illustrating an example of a hardware implementation for an apparatus 2300 employing a processing system 2314. The processing system 2314 may be implemented with a bus architecture, represented generally by the bus 2324. The bus 2324 may include any number of interconnecting buses and bridges depending on the specific application of the processing system 2314 and the overall design constraints. The bus 2324 links together various circuits including one or more processors and/or hardware modules, represented by the processor 2322 the modules 2302, 2304 and the non-transitory computer-readable medium 2326. The bus 2324 may also link various other circuits such as timing sources, peripherals, voltage regulators, and power management circuits, which are well known in the art, and therefore, will not be described any further.

The apparatus includes a processing system 2314 coupled to a transceiver 2330. The transceiver 2330 is coupled to one or more antennas 2320. The transceiver 2330 enables communicating with various other apparatus over a transmission medium. The processing system 2314 includes a processor 2322 coupled to a non-transitory computer-readable medium 2326. The processor 2322 is responsible for general processing, including the execution of software stored on the computer-readable medium 2326. The software, when executed by the processor 2322, causes the processing system 2314 to perform the various functions described for any particular apparatus. The computer-readable medium 2326 may also be used for storing data that is manipulated by the processor 2322 when executing software.

The processing system 2314 includes a receiving module 2302, a receiver or transceiver for receiving a handover command from one or more serving cells of a first RAT. The processing system 2314 also includes a determining module 2304 for determining whether a communication condition is satisfied. The determining module 2304 also determines whether to perform a synchronization channel decoding procedure for a synchronized handover to a second radio access technology (RAT) after receiving the handover command from one or more serving cells of the first RAT based on whether the communication condition is satisfied. The modules 2302 and 2304 may be software modules running in the processor 2322, resident/stored in the computer-readable medium 2326, one or more hardware modules coupled to the processor 2322, or some combination thereof. The processing system 2314 may be a component of the UE 750 of FIG. 7 and may include the memory 760, and/or the controller/processor 759.

The UE 750 is configured to include means for receiving. In one aspect, the receiving means may include the antenna 752, the antenna 2320, receiver 754, transceiver 2330, receive processor 756, the controller/processor 759, the memory 760, the handover module 791, the receiving module 2302, and/or the processing system 2314 configured to perform the functions recited by the receiving means. In one configuration, the means and functions correspond to the aforementioned structures. In another aspect, the aforementioned means may be a module or any apparatus configured to perform the functions recited by the searching means.

In one configuration, an apparatus such as a UE 750 is configured for wireless communication including means for determining and/or means for performing the synchronization channel decoding procedure. In one aspect, the determining means and/or the synchronization channel decoding procedure means may be the receive processor 756, the controller/processor 759, the memory 760, the handover module 791, the determining module 2304, and/or the processing system 2314 configured to perform the aforementioned means. In one configuration, the means functions correspond to the aforementioned structures. In another aspect, the aforementioned means may be a module or any apparatus configured to perform the functions recited by the aforementioned means.

Several aspects of a telecommunications system has been presented with reference to LTE and GSM systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal-to-noise ratio (SNR), signal to interference plus noise ratio (SINR), etc.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving a handover command from at least one serving cell of a first RAT (radio access technology);
determining whether a communication condition is satisfied; and
determining whether to perform a synchronization channel decoding procedure for a synchronized handover to a second RAT after receiving the handover command from the at least one serving cell of the first RAT based at least in part on whether the communication condition is satisfied.

2. The method of claim 1, in which determining whether the communication condition is satisfied further comprises determining whether a change in path loss of a communication link between a UE (user equipment) and a base station is greater than a threshold; and
the method further comprises performing the synchronization channel decoding procedure when the change in the path loss of the communication link is greater than the threshold.

3. The method of claim 1, in which determining whether the communication condition is satisfied further comprises determining whether a measured Doppler frequency of a UE (user equipment) is greater than a threshold; and
the method further comprises performing the synchronization channel decoding procedure for the synchronized handover when the measured Doppler frequency of the UE is greater than the threshold.

4. The method of claim 1, in which determining whether the communication condition is satisfied further comprises determining whether a speed of a UE (user equipment) is greater than a threshold; and
the method further comprises performing the synchronization channel decoding procedure for the synchronized handover when the speed of the UE is greater than the threshold.

5. The method of claim 1, in which determining whether the communication condition is satisfied further comprises determining whether an uplink timing change indicated by TA commands (timing advance commands) exceeds a threshold before a UE (user equipment) receives the handover command; and
the method further comprises performing the synchronization channel decoding procedure for the synchronized handover when the uplink timing change indicated by the timing advance commands exceeds the threshold before the UE receives the handover command.

6. The method of claim 1, in which determining whether the communication condition is satisfied further comprises determining whether a latency specification for at least one application running on a UE (user equipment) is below a threshold; and
the method further comprises performing the synchronization channel decoding procedure for the synchronized handover when the latency specification for the at least one application running on the UE is below the threshold.

7. The method of claim 1, in which determining whether the communication condition is satisfied further comprises determining whether a signal quality of the second RAT is below a threshold; and
the method further comprises performing the synchronization channel decoding procedure for the synchronized handover when the signal quality of the second RAT is below the threshold.

8. The method of claim 1, in which determining whether the communication condition is satisfied further comprises determining whether a handover preparation time exceeds a threshold; and
the method further comprises performing the synchronization channel decoding procedure for the synchronized handover when the handover preparation time exceeds the threshold.

9. The method of claim 1, in which determining whether the communication condition is satisfied further comprises determining whether the at least one serving cell of the first RAT and/or a target cell of the second RAT indicate a high speed flag in a dedicated signaling message and/or a broadcast system information message; and
the method further comprises performing the synchronization channel decoding procedure for the synchronized handover when the at least one serving cell of the first RAT and/or the target cell of the second RAT indicate the high speed flag in the dedicated signaling message and/or the broadcast system information message.

10. The method of claim 1, further comprising performing the synchronization channel decoding procedure for a single radio-voice call continuity (SRVCC) handover.

11. An apparatus for wireless communication, comprising:
means for receiving a handover command from at least one serving cell of a first RAT (radio access technology);
means for determining whether a communication condition is satisfied; and
means for determining whether to perform a synchronization channel decoding procedure for a synchronized handover to a second RAT after receiving the handover command from the at least one serving cell of the first RAT based at least in part on whether the communication condition is satisfied.

12. The apparatus of claim 11, in which the means for determining whether the communication condition is satisfied further comprises means for determining whether a change in path loss of a communication link between a UE (user equipment) and a base station is greater than a threshold; and
the apparatus further comprises means for performing the synchronization channel decoding procedure when the change in the path loss of the communication link is greater than the threshold.

13. The apparatus of claim 11, in which the means for determining whether the communication condition is satisfied further comprises means for determining whether a measured Doppler frequency of a UE (user equipment) is greater than a threshold; and
the apparatus further comprises means for performing the synchronization channel decoding procedure for the synchronized handover when the measured Doppler frequency of the UE is greater than the threshold.

14. The apparatus of claim 11, in which the means for determining whether the communication condition is satisfied further comprises means for determining whether a speed of a UE (user equipment) is greater than a threshold; and
the apparatus further comprises means for performing the synchronization channel decoding procedure for the synchronized handover when the speed of the UE is greater than the threshold.

15. The apparatus of claim 11, in which the means for determining whether the communication condition is satisfied further comprises means for determining whether an uplink timing change indicated by TA commands (timing advance commands) exceeds a threshold before a UE (user equipment) receives the handover command; and
the apparatus further comprises means for performing the synchronization channel decoding procedure for the synchronized handover when the uplink timing change indicated by the timing advance commands exceeds the threshold before the UE receives the handover command.

16. An apparatus for wireless communication, comprising:
a memory; and
at least one processor coupled to the memory and configured:
to receive a handover command from at least one serving cell of a first RAT (radio access technology);
to determine whether a communication condition is satisfied; and
to determine whether to perform a synchronization channel decoding procedure for a synchronized handover to a second RAT after receiving the handover command from the at least one serving cell of the first RAT based at least in part on whether the communication condition is satisfied.

17. The apparatus of claim 16, in which the at least one processor is further configured to determine whether the communication condition is satisfied by determining whether a change in path loss of a communication link between a UE (user equipment) and a base station is greater than a threshold; and
in which the at least one processor is further configured to perform the synchronization channel decoding procedure when the change in the path loss of the communication link is greater than the threshold.

18. The apparatus of claim 16, in which the at least one processor is further configured to determine whether the communication condition is satisfied by determining whether a measured Doppler frequency of a UE (user equipment) is greater than a threshold; and
in which the at least one processor is further configured to perform the synchronization channel decoding procedure for the synchronized handover when the measured Doppler frequency of the UE is greater than the threshold.

19. The apparatus of claim 16, in which the at least one processor is further configured to determine whether the communication condition is satisfied by determining whether a speed of a UE (user equipment) is greater than a threshold; and
in which the at least one processor is further configured to perform the synchronization channel decoding procedure for the synchronized handover when the speed of the UE is greater than the threshold.

20. The apparatus of claim 16, in which the at least one processor is further configured to determine whether the communication condition is satisfied by determining whether an uplink timing change indicated by TA commands (timing advance commands) exceeds a threshold before a UE (user equipment) receives the handover command; and
in which the at least one processor is further configured to perform the synchronization channel decoding procedure for the synchronized handover when the uplink timing change indicated by the timing advance commands exceeds the threshold before the UE receives the handover command.

21. The apparatus of claim 16, in which the at least one processor is further configured to determine whether the communication condition is satisfied by determining whether a latency specification for at least one application running on a UE (user equipment) is below a threshold; and
in which the at least one processor is further configured to perform the synchronization channel decoding procedure for the synchronized handover when the latency specification for the at least one application running on the UE is below the threshold.

22. The apparatus of claim 16, in which the at least one processor is further configured to determine whether the communication condition is satisfied by determining whether a signal quality of the second RAT is below a threshold; and
in which the at least one processor is further configured to perform the synchronization channel decoding procedure for the synchronized handover when the signal quality of the second RAT is below the threshold.

23. The apparatus of claim 16, in which the at least one processor is further configured to determine whether the communication condition is satisfied by determining whether a handover preparation time exceeds a threshold; and
in which the at least one processor is further configured to perform the synchronization channel decoding procedure for the synchronized handover when the handover preparation time exceeds the threshold.

24. The apparatus of claim 16, in which the at least one processor is further configured to determine determining whether the communication condition is satisfied by determining whether the at least one serving cell of the first RAT and/or a target cell of the second RAT indicate a high speed flag in a dedicated signaling message and/or a broadcast system information message; and
in which the at least one processor is further configured to perform the synchronization channel decoding procedure for the synchronized handover when the at least one serving cell of the first RAT and/or the target cell of the second RAT indicate the high speed flag in the dedicated signaling message and/or the broadcast system information message.

25. The apparatus of claim 16, in which the at least one processor is further configured to perform the synchronization channel decoding procedure for a single radio-voice call continuity (SRVCC) handover.

26. A non-transitory computer-readable medium having program code recorded thereon, the program code comprising:
program code to receive a handover command from at least one serving cell of a first RAT (radio access technology);
program code to determine whether a communication condition is satisfied; and
program code to determine whether to perform a synchronization channel decoding procedure for a synchronized handover to a second RAT after receiving the handover command from the at least one serving cell of the first RAT based at least in part on whether the communication condition is satisfied.

27. The non-transitory computer-readable medium of claim 26, in which the program code to determine whether a communication condition is satisfied further comprises program code to determine whether a change in path loss of a communication link between a UE (user equipment) and a base station is greater than a threshold; and
in which the non-transitory computer-readable medium further comprises program code to perform the synchronization channel decoding procedure when the change in the path loss of the communication link is greater than the threshold.

28. The non-transitory computer-readable medium of claim 26, in which the program code to determine whether a communication condition is satisfied further comprises program code to determine whether a measured Doppler frequency of a UE (user equipment) is greater than a threshold; and
in which the non-transitory computer-readable medium further comprises program code to perform the synchronization channel decoding procedure for the synchronized handover when the measured Doppler frequency of the UE is greater than the threshold.

29. The non-transitory computer-readable medium of claim 26, in which the program code to determine whether a communication condition is satisfied further comprises program code to whether a speed of a UE (user equipment) is greater than a threshold; and
in which the non-transitory computer-readable medium further comprises program code to perform the synchronization channel decoding procedure for the synchronized handover when the speed of the UE is greater than the threshold.

30. The non-transitory computer-readable medium of claim 26, in which the program code to determine whether a communication condition is satisfied further comprises program code to determine whether an uplink timing change indicated by TA commands (timing advance commands) exceeds a threshold before a UE (user equipment) receives the handover command; and
in which the non-transitory computer-readable medium further comprises program code to perform the synchronization channel decoding procedure for the synchronized handover when the uplink timing change indicated by the timing advance commands exceeds the threshold before the UE receives the handover command.
